(19) United States
(12) Patent Application Publication
(10) Pub. No.: US 2020/0126069 A1
(43) Pub. Date: Apr. 23, 2020

(54) DATA PROCESSING METHOD, APPARATUS AND DEVICE

(71) Applicant: Alibaba Group Holding Limited, George Town (KY)

(72) Inventor: Zhiwei CUI, Hangzhou (CN)

(73) Assignee: Alibaba Group Holding Limited

(21) Appl. No.: 16/716,992

(22) Filed: Dec. 17, 2019

Related U.S. Application Data
(63) Continuation of application No. PCT/CN2018/094318, filed on Jul. 3, 2018.

(30) Foreign Application Priority Data
Jul. 3, 2017 (CN) 201710532441.X

(51) Int. Cl. G06Q 20/36; G06Q 20/40; G06Q 20/38

(52) U.S. Cl. CPC G06Q 20/3676; G06Q 20/387; G06Q 20/3674; G06Q 20/4016

(57) ABSTRACT

A data processing method includes: sending, by a cost balancing subsystem, an authentication request about a user to a cost transfer subsystem, the authentication request requesting authentication of the user; sending, by the cost transfer subsystem according to an authentication result, a directed electronic voucher to a client terminal of the user, the directed electronic voucher being used as a payment voucher for a directed resource cost of the user; sending, by a resource subsystem according to the directed electronic voucher presented by the client terminal of the user, a payment request to the cost balancing subsystem through the cost transfer subsystem, the payment request requesting payment of the resource cost of the user; and confirming, by the cost balancing subsystem, the payment request and transferring, by the cost balancing subsystem, the resource cost of the user to the resource subsystem through the cost transfer subsystem.

### CROSS-REFERENCE TO RELATED APPLICATIONS

This application is a continuation application of International Application No. PCT/CN2018/094318, filed on Jul. 3, 2018, which is based upon and claims priority to Chinese Patent Application No. 201710532441.X, filed on Jul. 3, 2017, the entire content of all of which is incorporated herein by reference.

### TECHNICAL FIELD

This application relates to the field of computer software technologies, and in particular, to a data processing method, apparatus and device.

### TECHNICAL BACKGROUND

In an existing resource transfer system, a user terminal pays a resource cost to a resource system according to a resource event triggered in the resource system, and balances the resource cost paid by the user terminal through a cost balancing system. A cost balancing subsystem receives the resource cost of the user terminal in advance, and pays the resource cost in the resource event for the user terminal when the user terminal triggers the resource event, thus achieving the resource cost balance of the user terminal.

In some cases, the cost balancing system pays the resource cost in advance for the user terminal, but the user terminal may not trigger the resource event, or the resource cost in the resource event of the user terminal is less than the resource cost paid by the cost balancing system, resulting in that the cost balance system may pay an additional resource cost. In other cases, the user terminal pays the resource cost in the resource system on its own in advance, but may adopt a complicated method and waits for a long time before the resource cost paid by the cost balancing system can be obtained.

There is an urgent need for a solution that allows the user terminal to reduce a period of advance payment of the resource cost while reducing or avoiding an additional resource cost paid by the cost balancing system.

### SUMMARY

An objective of embodiments of this application is to provide a data processing method, apparatus and device that allow a user terminal to reduce a period of advance payment of a resource cost while reducing or avoiding an additional resource cost paid by a cost balancing system.

To solve the above technical problem, the embodiments of this application are implemented as follows.

According to one aspect, a data processing method includes: sending, by a cost balancing subsystem, an authentication request about a user to a cost transfer subsystem, the authentication request requesting authentication of the user; sending, by the cost transfer subsystem according to an authentication result, a directed electronic voucher to a client terminal of the user, the directed electronic voucher being used as a payment voucher for a directed resource cost of the user; sending, by a resource subsystem according to the directed electronic voucher, a payment request to the cost balancing subsystem through the cost transfer subsystem, the directed electronic voucher being presented by the client terminal of the user, and the payment request requesting payment of the resource cost of the user; and confirming, by the cost balancing subsystem, the payment request and transferring, by the cost balancing subsystem, the resource cost of the user to the resource subsystem through the cost transfer subsystem.

According to another aspect, a data processing method, which is applied to a cost balancing subsystem, includes: sending an authentication request about a user to a cost transfer subsystem, the authentication request requesting authentication of the user; receiving a payment request sent by the cost transfer subsystem, wherein the payment request requests payment of a resource cost of a client terminal of the user and is sent by a resource subsystem according to a directed electronic voucher presented by the client terminal of the user, and the directed electronic voucher is sent to the client terminal of the user by the cost transfer subsystem according to an authentication result; and confirming the payment request and transferring the resource cost of the user to the resource subsystem through the cost transfer subsystem.

According to still another aspect, a data processing method, which is applied to a cost transfer subsystem, includes: receiving an authentication request about a user sent by a cost balancing subsystem, the authentication request requesting authentication of the user; authenticating the user, and sending a directed electronic voucher to a client terminal of the user according to an authentication result, the directed electronic voucher being used as a payment voucher for a directed resource cost of the client terminal of the user; receiving a payment request sent by a resource subsystem according to the directed electronic voucher, the directed electronic voucher being presented by the client terminal of the user, and the payment request requesting payment of a resource cost of the client terminal of the user; forwarding the payment request to the cost balancing subsystem; receiving a payment instruction sent by the cost balancing subsystem according to the payment request, the payment instruction being configured to pay the resource cost of the client terminal of the user to the resource subsystem; and paying the resource cost of the client terminal of the user to the resource subsystem from the cost balancing subsystem according to the payment instruction.

According to still another aspect, a data processing method, which is applied to a resource subsystem, includes: sending, through a cost transfer subsystem, a payment request to a cost balancing subsystem according to a directed electronic voucher presented by a client terminal of a user, the payment request requesting payment of a resource cost of the user, wherein the directed electronic voucher is sent to the client terminal of the user by the cost transfer subsystem according to an authentication result for an authentication request about the user from the cost balancing subsystem, and the directed electronic voucher is used as a payment voucher for a directed resource cost of the user; and receiving the resource cost of the user transferred by the cost transfer subsystem from the cost balancing subsystem according to a payment instruction, wherein the payment instruction is sent by the cost balancing subsystem to the cost transfer subsystem after the payment request forwarded by the cost transfer subsystem is confirmed, and the payment instruction is configured to pay the resource cost of the user.

According to still another aspect, an electronic device includes: a processor; and a memory arranged to store a computer executable instruction, wherein when executed, the executable instruction causes the processor to perform the following operations: sending an authentication request about a user to a cost transfer subsystem, the authentication request requesting authentication of the user; receiving a payment request sent by the cost transfer subsystem, wherein the payment request requests payment of a resource cost of a client terminal of the user and is sent by a resource subsystem according to a directed electronic voucher presented by the client terminal of the user, and the directed electronic voucher is sent to the client terminal of the user by the cost transfer subsystem according to an authentication result; and confirming the payment request and transferring the resource cost of the user to the resource subsystem through the cost transfer subsystem.

According to still another aspect, an electronic device includes: a processor; and a memory arranged to store a computer executable instruction, wherein when executed, the executable instruction causes the processor to perform the following operations: receiving an authentication request about a user sent by a cost balancing subsystem, the authentication request requesting authentication of the user; authenticating the user, and sending a directed electronic voucher to a client terminal of the user according to an authentication result, the directed electronic voucher being used as a payment voucher for a directed resource cost of the client terminal of the user; receiving a payment request sent by a resource subsystem according to the directed electronic voucher, the directed electronic voucher being presented by the client terminal of the user, and the payment request requesting payment of a resource cost of the client terminal of the user; forwarding the payment request to the cost balancing subsystem; receiving a payment instruction sent by the cost balancing subsystem according to the payment request, the payment instruction being configured to pay the resource cost of the client terminal of the user to the resource subsystem; and paying the resource cost of the client terminal of the user to the resource subsystem from the cost balancing subsystem according to the payment instruction.

According to still another aspect, an electronic device includes: a processor; and a memory arranged to store a computer executable instruction, wherein when executed, the executable instruction causes the processor to perform the following operations: sending, through a cost transfer subsystem, a payment request to a cost balancing subsystem according to a directed electronic voucher presented by a client terminal of a user, the payment request requesting payment of a resource cost of the user, wherein the directed electronic voucher is sent to the client terminal of the user by the cost transfer subsystem according to an authentication result for an authentication request about the user from the cost balancing subsystem, and the directed electronic voucher is used as a payment voucher for a directed resource cost of the user; and receiving the resource cost of the user transferred by the cost transfer subsystem from the cost balancing subsystem according to a payment instruction, wherein the payment instruction is sent by the cost balancing subsystem to the cost transfer subsystem after the payment request forwarded by the cost transfer subsystem is confirmed, and the payment instruction is configured to pay the resource cost of the user.

According to still another aspect, a computer readable storage medium storing one or more programs is proposed. When executed by an electronic device including multiple applications, the one or more programs cause the electronic device to perform the following operations: sending an authentication request about a user to a cost transfer subsystem, the authentication request requesting authentication of the user; receiving a payment request sent by the cost transfer subsystem, wherein the payment request requests payment of a resource cost of a client terminal of the user and is sent by a resource subsystem according to a directed electronic voucher presented by the client terminal of the user, and the directed electronic voucher is sent to the client terminal of the user by the cost transfer subsystem according to an authentication result; and confirming the payment request and transferring the resource cost of the user to the resource subsystem through the cost transfer subsystem.

According to still another aspect, a computer readable storage medium storing one or more programs is proposed. When executed by an electronic device including multiple applications, the one or more programs cause the electronic device to perform the following operations: receiving an authentication request about a user sent by a cost balancing subsystem, the authentication request requesting authentication of the user; sending a directed electronic voucher to a client terminal of the user according to an authentication result, the directed electronic voucher being used as a payment voucher for a directed resource cost of the client terminal of the user; receiving a payment request sent by a resource subsystem according to the directed electronic voucher, the directed electronic voucher being presented by the client terminal of the user, and the payment request requesting payment of the resource cost of the client terminal of the user; forwarding the payment request to the cost balancing subsystem; receiving a payment instruction sent by the cost balancing subsystem according to the payment request, the payment instruction being configured to pay the resource cost of the client terminal of the user to the resource subsystem; and paying the resource cost of the client terminal of the user to the resource subsystem from the cost balancing subsystem according to the payment instruction.

According to still another aspect, a computer readable storage medium storing one or more programs is proposed. When executed by an electronic device including multiple applications, the one or more programs cause the electronic device to perform the following operations: sending, through a cost transfer subsystem, a payment request to a cost balancing subsystem according to a directed electronic voucher presented by a client terminal of a user, the payment request requesting payment of a resource cost of the user, wherein the directed electronic voucher is sent to the client terminal of the user by the cost transfer subsystem according to an authentication result for an authentication request about the user from the cost balancing subsystem, and the directed electronic voucher is used as a payment voucher for a directed resource cost of the user; and receiving the resource cost of the user transferred by the cost transfer subsystem from the cost balancing subsystem according to a payment instruction, wherein the payment instruction is sent by the cost balancing subsystem to the cost transfer subsystem after the payment request forwarded by the cost transfer subsystem is confirmed, and the payment instruction is configured to pay the resource cost of the user.

According to yet still another aspect, a data processing system includes a cost balancing subsystem, a cost transfer subsystem, a resource subsystem, and a user client terminal subsystem. The cost balancing subsystem is configured to send an authentication request about a user to the cost transfer subsystem, the authentication request requesting authentication of the user. The cost transfer subsystem is configured to receive the authentication request, and send a directed electronic voucher to the user client terminal subsystem of the user according to an authentication result, the directed electronic voucher being used as a payment voucher for a directed resource cost of the user. The user client terminal subsystem is configured to receive the directed electronic voucher about the user sent by the cost transfer subsystem, and present the directed electronic voucher to the resource subsystem. The resource subsystem is configured to send, according to the directed electronic voucher, a payment request to the cost balancing subsystem through the cost transfer subsystem, the directed electronic voucher being presented by the client terminal of the user, and the payment request requesting payment of the resource cost of the user. The cost balancing subsystem is further configured to confirm the payment request and transfer the resource cost of the user to the resource subsystem through the cost transfer subsystem.

It can be seen that the technical solutions in the embodiments of this application complete the authentication of the user and issue the directed electronic voucher through the cost transfer subsystem, and request payment of the resource cost corresponding to the directed electronic voucher from the cost balancing subsystem according to the directed electronic voucher at the resource subsystem. Then, the payment of the resource cost is completed through the cost transfer subsystem according to the confirmation of the cost balancing subsystem for the payment, thereby enabling the user terminal to reduce a period of advance payment of the resource cost while reducing or avoiding an additional resource cost paid by the cost balancing system.

### BRIEF DESCRIPTION OF THE DRAWINGS

In order to illustrate the technical solutions in the embodiments of the specification more clearly, the accompanying drawings to be used in descriptions of the embodiments will be briefly described below.

FIG. 1 is a flowchart of a data processing method according to an embodiment.

FIG. 2 is an interactive flowchart of an insurance claim according to an embodiment.

FIG. 3 is an interactive flowchart of an insurance claim according to another embodiment.

FIG. 4 is a flowchart of a data processing method according to another embodiment.

FIG. 5 is a flowchart of a data processing method according to still another embodiment.

FIG. 6 is a flowchart of a data processing method according to still another embodiment.

FIG. 7 is a schematic diagram of an electronic device according to an embodiment.

FIG. 8 is a schematic diagram of a data processing apparatus according to an embodiment.

FIG. 9 is a schematic diagram of an electronic device according to an embodiment.

FIG. 10 is a schematic diagram of a data processing apparatus according to an embodiment.

FIG. 11 is a schematic diagram of an electronic device according to an embodiment.

FIG. 12 is a schematic diagram of a data processing apparatus according to an embodiment.

### DETAILED DESCRIPTION

A method and system for settling an insurance service claim, and a server terminal of a payment system are provided in embodiments of this application.

The technical solutions in the embodiments will be described below with reference to the accompanying drawings. The described embodiments are only exemplary rather than all of the embodiments of this application. All other embodiments derived by those of ordinary skill in the art based on the embodiments of this application without creative efforts should fall within the protection scope of this application.

For a better understanding of a cost balancing subsystem, a resource system, and a user terminal in this application, a claim settlement scenario is taken as an example for illustration in the embodiments of this application. The user terminal may correspond to, for example, a user insured by an insurance company. The cost balancing subsystem may be, for example, the insurance company that collects insurance premiums from the user and pays the claim settlement fee of repairing a vehicle for the user, thus achieving a balance of the user's fee. The resource system may be, for example, a 4S shop/garage that provides vehicle repair (resource) for the user, and charges for the vehicle repair (resource cost). The user terminal may trigger a resource event when, for example, the user has his/her vehicle repaired at the 4S shop/garage.

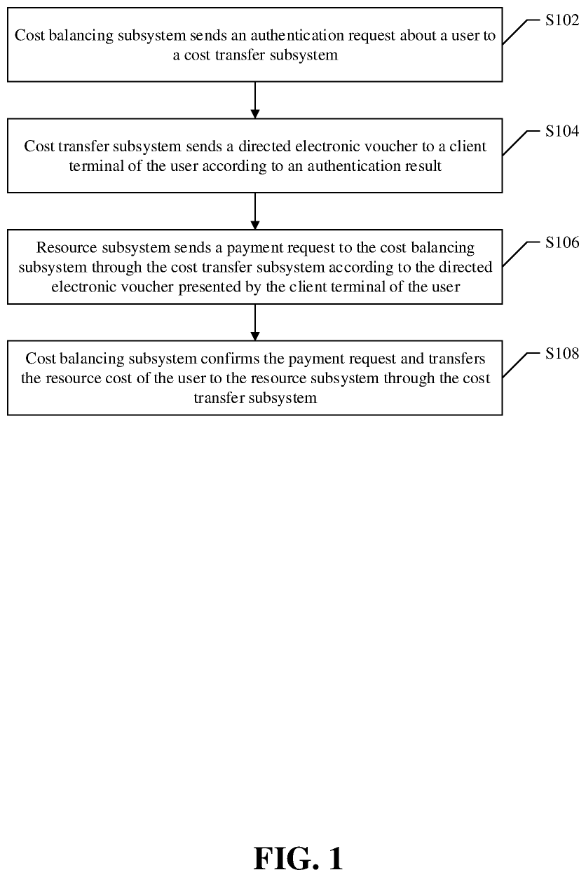

FIG. 1 is a flowchart of a data processing method according to an embodiment. The data processing method may include the following steps.

In S102, a cost balancing subsystem sends an authentication request about a user to a cost transfer subsystem.

The authentication request is used for requesting authentication of the user.

In the embodiment, the cost balancing subsystem may be configured to balance a directed resource cost of the user, and pay the directed resource cost to the resource system for the user.

In the embodiment, the authentication request is used for requesting authentication of the user. For example, the authentication of the user may include: authenticating whether an account corresponding to the user exists in the cost transfer subsystem; and/or authenticating a credit indicator or a risk indicator of the user.

In S104, the cost transfer subsystem sends a directed electronic voucher to a client terminal of the user according to an authentication result.

The directed electronic voucher is used as a payment voucher for the directed resource cost of the user.

In the embodiment, the cost transfer subsystem is configured to transfer the resource cost. For example, the cost transfer subsystem is configured to transfer the resource cost from the cost balancing subsystem to a resource subsystem.

Moreover, in the embodiment, the cost transfer subsystem is further provided with an authentication function to authenticate the user.

In S106, the resource subsystem sends a payment request to the cost balancing subsystem through the cost transfer subsystem according to the directed electronic voucher presented by the client terminal of the user.

The payment request is used for requesting payment of the resource cost of the user.

In the embodiment, the resource subsystem is configured to provide a resource to the user and charge the resource cost. In a specific application, the resource may include a tangible resource or an intangible resource, such as a service resource, and the like.

In S108, the cost balancing subsystem confirms the payment request and transfers the resource cost of the user to the resource subsystem through the cost transfer subsystem.

Taking the insurance claim settlement of the insurance company as an example, the solution of the embodiment can be implemented as follows.

An insurance service provider sends an authentication request about a user to a server terminal of a payment system, wherein the authentication request is used for requesting authentication of the user.

The server terminal of the payment system authenticates the user, and after the user passes the authentication, sends an insurance voucher to an account of the user in the payment system, wherein the insurance voucher is used for settlement of the claim settlement fee of the user.

An insurance service servicer uses the insurance voucher of the user to complete the settlement of the claim settlement fee of the user.

The insurance service servicer sends an insurance voucher settlement request to the server terminal of the payment system, wherein the insurance voucher settlement request is used for requesting settlement of the claim settlement fee.

The server terminal of the payment system sends a payment request to the insurance service provider according to the insurance voucher settlement request, wherein the payment request is used for requesting payment of the claim settlement fee.

The insurance service provider reviews and confirms the claim settlement fee corresponding to the insurance voucher according to the payment request.

After the review is passed, a payment instruction is sent to the server terminal of the payment system, wherein the payment instruction is used for paying the claim settlement fee corresponding to the insurance voucher from an account of the insurance service provider to an account of the insurance service servicer.

In the embodiment, the authentication of the user is completed and the directed electronic voucher is issued through the cost transfer subsystem, and payment of the resource cost corresponding to the directed electronic voucher is requested from the cost balancing subsystem through the cost transfer subsystem according to the directed electronic voucher at the resource subsystem. Then, the payment of the resource cost is completed through the cost transfer subsystem according to the confirmation of the payment by the cost balancing subsystem, thereby enabling the user terminal to reduce the period of advance payment of the resource cost while reducing or avoiding an additional resource cost paid by the cost balancing system.

In an embodiment, information of the directed resource that is directed to the user may be further carried in the authentication request and the directed electronic voucher. Identification information of the directed resource that is directed to the user may be used for identifying an object having the permission of using the directed electronic voucher. Further, the identification information of the directed resource that is directed to the user is used for determining the resource cost that the cost balancing subsystem should bear.

The information of the directed resource that is directed to the user may include identification information of an object that will use the directed resource, and/or identification information of the user. For example, in a vehicle insurance claim, an object that will use the directed resource is an insured vehicle, and one or more types of identification information of the insured vehicle, such as a license plate number, a frame number, an engine number, a model, and color of a vehicle body, may be carried in the directed electronic voucher. The identification information of the user is, for example, one or more types of identification information such as an identity of the user, a mobile phone number, and the like.

The information of the directed resource that is directed to the user may further include identification information of the directed resource. For example, in the vehicle insurance claim, the identification information of the directed resource may be an identification of a repair project. For example, a repair project is to replace the windscreen with a domestic windscreen and the repair project has an identification number of 0111. The identification information of the directed resource may be in various manners, such as a name, a code, and the like.

In an embodiment, step S106 may be implemented as follows: when the object using the resource corresponding to the resource cost of the user is an object having the permission of using the directed electronic voucher, and the resource corresponding to the resource cost of the user includes at least one directed resource carried in the directed electronic voucher, the resource subsystem sends the payment request to the cost balancing subsystem through the cost transfer subsystem according to the directed electronic voucher presented by the client terminal of the user.

For example, in the vehicle insurance claim, a license plate number, a model, and a maintenance item may be carried in an insurance voucher issued by an insurance company, for paying for a repair cost of a designated repair project of the designated vehicle. In the garage, if the repaired vehicle is not a vehicle corresponding to the license plate number or is a vehicle of another model, the insurance voucher cannot be used; and if the repair project conducted in the garage does not include the repair project in the insurance voucher, the insurance voucher cannot be used either.

In an embodiment, validity period information may be further carried in the directed electronic voucher. The validity period information is used for defining an effective use period of the directed electronic voucher.

For example, if the validity period information of the insurance voucher issued by the insurance company is from Jun. 30, 2017 to Aug. 31, 2017, the user can only use the insurance voucher between Jun. 30, 2017 and Aug. 31, 2017; otherwise, the insurance voucher will be invalid.

Herein, step S106 may be implemented as follows: if the validity period information is carried in the directed electronic voucher and the current date is within the validity period, the resource subsystem sends the payment request to the cost balancing subsystem through the cost transfer subsystem according to the directed electronic voucher presented by the client terminal of the user.

In an embodiment, a resource subsystem identifier may be further carried in the directed electronic voucher. The resource subsystem identifier is used for defining a resource subsystem having the permission of using the directed electronic voucher.

For example, if a repair facility designated in the insurance voucher issued by the insurance company is a garage A and a 4S shop B, the user can only use the insurance voucher for repair at the garage A or 4S shop B. The insurance voucher may not be used in other repair facilities.

Herein, step S106 may be implemented as follows: if resource subsystem identifiers are carried in the directed electronic voucher and the identifier of the resource subsystem is one of the resource subsystem identifiers carried by the directed electronic voucher, the resource subsystem sends the payment request to the cost balancing subsystem through the cost transfer subsystem according to the directed electronic voucher presented by the client terminal of the user.

One or both of the validity period information and the resource subsystem identifier information may be carried in the directed electronic voucher. Accordingly, in step S106, the condition corresponding to the one or both of the validity period information and the resource subsystem identifier information shall be met.

In an embodiment, the authentication result may include a credit indicator/risk indicator of the user, and the credit indicator/risk indicator of the user may be carried in the directed electronic voucher.

Further, the receiving the directed electronic voucher by the client terminal of the user may include: if the credit indicator of the user is lower than a predetermined credit indicator, or the risk indicator of the user is higher than a predetermined risk indicator, performing risk authentication on the user, and confirming reception of the directed electronic voucher after the authentication succeeds.

In the embodiment, the risk authentication of the user may be performed according to the credit indicator or the risk indicator of the user when the user confirms reception of the directed electronic voucher, thereby further improving the security of the system.

Further, the credit indicator/risk indicator of the user may be further carried in the payment request. In step S108, the confirming, by the cost balancing subsystem, the payment request includes: confirming, by the cost balancing subsystem, the payment request according to a confirmation method corresponding to the credit indicator/risk indicator of the user.

In the embodiment, the corresponding confirmation method for confirming the payment request may be selected according to different credit indicators/risk indicators of users, thereby improving the confirmation efficiency while the risk is taken into consideration.

For example, in the vehicle insurance claim of the insurance company, if the risk indicator of the user is extremely high, the insurance company may review the payment request in a more rigorous confirmation method; if the risk indicator of the user is extremely low, the insurance company may review the payment request in a looser confirmation method such as, for example, an automatic confirmation.

Furthermore, in step S108, the confirming, by the cost balancing subsystem, the payment request may include: confirming, by the cost balancing subsystem, the payment request according to a confirmation method corresponding to the credit indicator/risk indicator of the user and the resource cost.

In the embodiment, the corresponding confirmation method for confirming the payment request may be selected according to different credit indicators/risk indicators of users and different resource costs, thereby improving the confirmation efficiency while the risk is taken into consideration.

For example, in medical insurance, if the credit indicator of the user is extremely high but the cost of reimbursement is also high, e.g., 200,000 yuan, then during the review for confirmation, the confirmation may not be made in a looser method by only considering the high credit indicator of the user, but the factor of the cost may also be taken into consideration.

In an embodiment, one of the following may be carried in the payment request:

the resource cost;

a resource item identifier, and a cost verification manner corresponding to the resource item identifier; and

a resource item identifier, a cost verification manner corresponding to the resource item identifier, and a resource cost proportion that the cost balancing subsystem should bear.

In an embodiment, after the cost balancing subsystem confirms providing the user with the directed resource cost directed to the user, the authentication request about the user may be sent to the cost transfer subsystem.

In an embodiment, the cost balancing subsystem may include a fee settlement system applied to the insurance company. The cost transfer subsystem may include a payment system. The resource subsystem may include a fee settlement system applied to a garage, a 4S shop, or a medical insurance point.

In the following, the method of the embodiment is further introduced with reference to the scenario of an insurance claim.

In an embodiment, after a user reports an insurance claim and passes the review and confirmation by the insurance service provider, the insurance service provider may send an authentication request of the user to the server terminal of the payment system.

In the embodiment, the authentication request may be sent to the server terminal of the payment system after the user reports the insurance claim and passes the review and confirmation.

In an embodiment, the insurance service provider may send the authentication request of the user to the server terminal of the payment system after the user and the insurance service provider sign a contract of insurance service.

In the embodiment, the authentication request may be sent to the server terminal of the payment system after the user signs the contract with the insurance service provider.

In an embodiment, risk information of the user may be further carried in the payment request. The insurance service provider may determine a review level corresponding to the risk information of the user, and may review the claim settlement fee corresponding to the insurance voucher at the review level.

In the embodiment, by carrying the risk information of the user in the payment request, the insurance service provider may determine the review level of the payment confirmation for different risk levels of different users, thereby ensuring the security review of the payment while taking the review efficiency into consideration.

The risk information of the user is only a reference factor for determining the review level. Other factors, for example, a frequency at which payment confirmation is made for insurance claims by the user, the amount of money in the payment request, and the like, may also be taken into consideration.

In an embodiment, the determining, by the insurance service provider, the review level corresponding to the risk information of the user, and reviewing the claim settlement fee corresponding to the insurance voucher at the review level includes: when the risk indicator of the user is less than the predetermined threshold, directly confirming the claim settlement fee corresponding to the insurance voucher.

In the embodiment, for a user whose risk indicator is less than the predetermined threshold, the risk is extremely small, and the possibility of a fraudulent insurance claim is extremely low, so the claim settlement fee corresponding to the insurance voucher can be directly confirmed.

In an embodiment, information related to the claim settlement fee may be carried in an insurance voucher settlement request, and the information related to the claim settlement fee may include one of the following:

the amount of the claim settlement fee corresponding to the insurance voucher;

a charging item and a settlement method corresponding to the insurance voucher;

a charging item, a bearing proportion of the insurance service servicer, and a settlement method corresponding to the insurance voucher.

The method in the embodiment will be further described below with reference to specific embodiments.

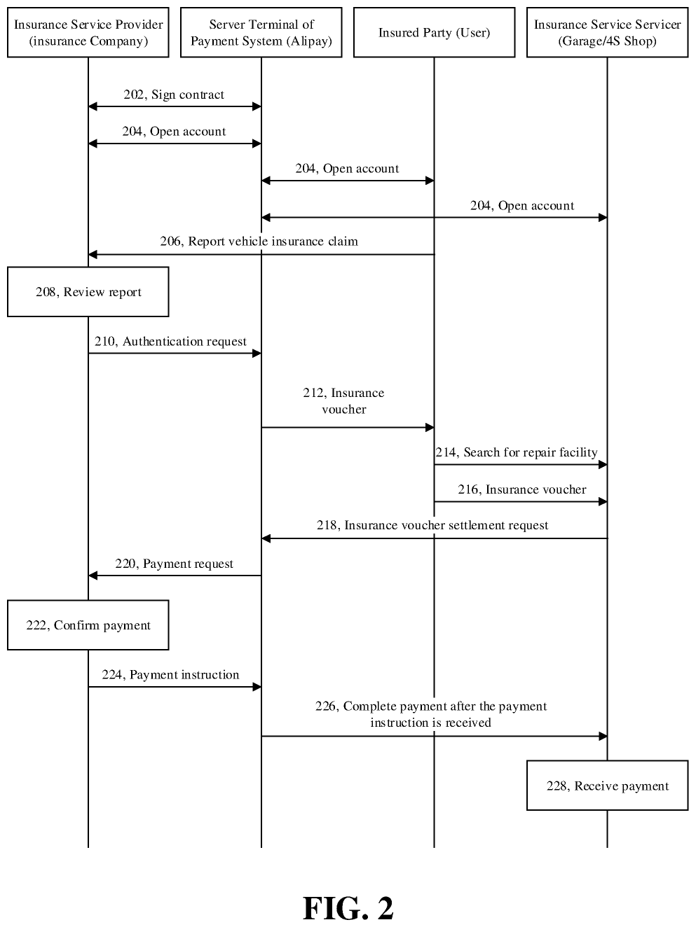

FIG. 2 is an interactive flowchart of a vehicle insurance claim according to an embodiment. In the embodiment, a cost balance subsystem is an insurance service provider or an insurance company; a resource subsystem is an insurance service servicer such as a garage/4S shop; and a cost transfer subsystem is a server terminal of the payment system.

In 202, the insurance company signs a contract with the server terminal of the payment system.

In the preparation stage, the insurance company may complete signing with the server terminal of the payment system such as, for example, Alipay or the like, to obtain a voucher issue function. As such, the insurance company can have the permission of issuing an insurance voucher to a user.

In the embodiment, the insurance voucher is a voucher for the user to obtain vehicle repair service at the garage/4S shop and pay the garage/4S shop.

In 204, related parties of the insurance claim open accounts at the server terminal of the payment system.

In the embodiment, the related parties of the insurance claim include an insured party (user), an insurance service provider (insurance company), and an insurance service servicer (garage/4S shop). The related parties of the insurance claim may open accounts in the payment system, so that the server terminal of the payment system such as Alipay can recognize the identity of a user.

The process of opening an account by the user may be similar to the process of opening a general account in the payment system, and will not be elaborated.

The insurance company may have functions of issuing an insurance voucher and confirming payment of the insurance voucher. The garage/4S shop may have a function of writing off the insurance voucher. It is usually necessary to set a permission different from that of an ordinary account. For example, the insurance company can cooperate with the server terminal of the payment system such as Alipay to open or register the account of the garage/4S shop, etc. At the same time, the insurance company may also open its own account in the payment system.

The server terminal of the payment system can be configured to identify the identity information of the user, not limited to the account. For example, other identifiers of the user may also be identified, which is not limited in the embodiment.

In 206, the user reports a vehicle insurance claim to the insurance company.

The user can report the vehicle insurance claim offline, or by a telephone, an APP, an online web page, or the like.

During reporting, information about the vehicle, such as a license plate number, a model, and a damaged part, may be provided. In addition, depending on the type of insurance under which the user is insured, the user may also need to provide different information. For example, in an accident, both parties must submit a self-negotiated settlement agreement or a traffic police certificate, third-party license plate number, driver information, information about whether the third party is insured for the mandatory traffic liability insurance, a third-party repair bill or a one-time negotiated payment certificate, and so on.

In 208, the insurance company performs a report review.

After the insurance company conducts survey, damage assessment, and underwriting according to the user's report information, and if it is determined that the user meets insurance compensation conditions, step 210 is performed; otherwise, the insurance company may reject the claim according to requirements in clauses.

In 210, the insurance company sends an authentication request to the server terminal of the payment system.

The insurance company sends the authentication request to the server terminal of the payment system through an interface with the server terminal of the payment system, requesting authentication of the user. The authentication of the user may be, for example, authentication of the identity of the user, including whether an account is opened in the payment system, and the like. For example, at least one type of identification information of the identity of the user, such as ID card information of the user, account information of the user, and a mobile phone number of the user, may be carried in the authentication request. In addition, the authentication of the user may also include credit authentication of the user.

An identifier of an object under the repair project corresponding to the insurance claim settlement fee, that is, an identifier of the insured vehicle, may also be carried in the authentication request. The identifier of the insured vehicle may be, for example, one or more of a license plate number, a model, a frame number, an engine number, and so on. In addition, the insurance company may also enable the authentication request to carry information about repair projects involved in the current vehicle insurance claim of the user, such as door replacement and windscreen replacement. The repair projects can be represented by project identifiers.

In the embodiment, the insurance company reviews the user by using the information of the user in the payment system, thereby avoiding the occurrence of insurance fraud to some extent.

In 212, the server terminal of the payment system sends an insurance voucher after the authentication succeeds.

After receiving the authentication request from the insurance company, the server terminal of the payment system may authenticate the user. In the embodiment, the server terminal of the payment system can authenticate whether the user has an Alipay account and whether a credit indicator/risk indicator of the user meets a preset insurance compensation condition.

The credit indicator/risk indicator of the user can be determined by various indicators such as the activeness of the user account, the credit score of the user account, the vehicle insurance score of the user account, and the like. The vehicle insurance score of the user account, for example, may be comprehensively determined according to relevant credit information such as the user's driving behavior, a historical accident record, Sesame credit records, a risk assessment level or a risk assessment indicator of the vehicle insured by the user, and the like. The preset insurance compensation condition may include, for example, one or more of the following: real-name authentication being opened, the activeness being greater than a first predetermined threshold, the credit score being greater than a second predetermined threshold, the vehicle risk score being greater than a third predetermined threshold, and the like.

If the server terminal of the payment system confirms that the user has not opened an account, the user may open an account, and then the insurance company resends the authentication request, or the server terminal of the payment system can periodically check whether the user has opened an account, and performs subsequent authentication after the user opens an account.

If the server terminal of the payment system authenticates the user and determines that the credit indicator/risk indicator of the user does not meet the preset insurance compensation condition, the user may be reminded to perform relevant operations to meet the preset insurance compensation condition, or relevant information is fed back to the insurance company. For example, if the user does not open the real-name authentication, the server terminal of the payment system may remind the user of opening the real-name authentication. For another example, if the server terminal of the payment system finds that the user's credit is extremely low and is blacklisted, the server terminal of the payment system may feed the information about the user being blacklisted back to the insurance company, and so on.

If the server terminal of the payment system confirms that the credit indicator/risk indicator of the user meets the preset insurance compensation condition after the authentication, the insurance voucher may be sent to the user. The identity of the user or the identity (vehicle license plate) information of the repaired vehicle may be carried in the insurance voucher. In the embodiment, the insurance voucher is a vehicle insurance claim voucher, which is used for payment for the repair cost corresponding to the type of vehicle insurance for the insured person in the vehicle insurance. In the embodiment, the proportion of the repair cost that the vehicle insurance claim voucher can pay is the proportion that the insurance company should bear in the repair cost, which may be all or a part of the repair cost.

The server terminal of the payment system may also record the credit indicator/risk indicator of the user in the insurance voucher.

In the payment stage, the insurance company may determine a standard of payment review based on the credit indicator/risk indicator of the user. The higher the risk of the user (the lower the credit) is, the stricter the standard of payment review is. The lower the risk of the user (the higher the credit) is, the looser the standard of payment review is, and the payment can even be confirmed directly without review.

At this time, the user who meets the insurance compensation condition will receive information of the insurance voucher sent by Alipay.

If the risk of the user is higher than the predetermined threshold, risk verification may be added in the process of receiving the insurance voucher by the user. For example, face recognition is triggered by a payment application client terminal, and face information of the user is sent to the payment system for identity verification. If the verification succeeds, the user is allowed to receive the insurance voucher. If the verification fails, the user is rejected from receiving the insurance voucher. In addition, it may be prompted that the receiving user is illegal, which is recorded in the authentication information of the user.

In 214, the user searches for a repair facility.

Once the user receives the insurance voucher, he/she may search for a repair facility for repair. The user can find the repair facility contracted with the insurance company by an existing conventional means and go there for repair. For example, the user may consult the insurance company by phone, search by an online search engine, and so on.

A more convenient solution may also be adopted in the embodiment. For example, the user may search for a garage/4S shop contracted with the insurance company through a navigation module integrated in a client terminal of the payment system, such as GPS navigation, AR navigation, and map navigation. The user can search for a designated garage/4S shop. Or, the user can select, from a garage/4S shop list returned by the navigation module, a garage/4S shop that meets his/her requirements such as, for example, the nearest one, or the one having the most convenient transportation, or the one having the best reputation. Or, the user can select a specified range, and the navigation module returns a garage/4S shop within the specified range, and so on.

The server terminal of the payment system may also directly push appropriate garages/4S shops to the user for the user to choose from. The information pushed by the server terminal of the payment system may include one or more of a distance, road condition information, user review, and the like.

In the embodiment, by searching for a repair facility through the server terminal of the payment system, the user can directly search for a location of the repair facility through the client terminal of the payment system, thereby providing a better experience for the user.

In addition, because the garage/4S shop contracted with the insurance company may cancel the contract with the insurance company for some reason, searching by other means may result in that a found repair facility is not a designated repair facility of the insurance company. In the embodiment, the insurance company may maintain the information of repair facilities contracted with the insurance company in the payment system, thereby ensuring that the user navigates to a repair facility contracted with the insurance company according to the navigation function in the client terminal of the payment system.

In 216, the user uses the insurance voucher.

For example, the user may use the insurance voucher by code-scanning or being code-scanned during repair.

For example, when code-scanning by the user, an interface of the insurance voucher appears after the code scanning, and the insurance voucher is selected for use, thereby completing the use of the insurance voucher.

For example, when the user is code-scanned, after the user selects the insurance voucher, a barcode carrying the user identification information is displayed, or a barcode for indicating the insurance voucher identification is directly displayed, or the insurance voucher exists in the form of a barcode, and the user directly presents the insurance voucher. The barcode may be, for example, a one-dimensional code, a two-dimensional code, or the like.

The user can also use the insurance voucher in other manners. For example, the insurance voucher can also be a string of characters, which can be used by the user by entering the character string in client terminal software of the garage/4S shop.

In addition, in the information of the insurance voucher presented by the user, the current time stamp may also be carried to prevent the insurance voucher from being reused.

In 218, the garage/4S shop sends an insurance voucher settlement request to the server terminal of the payment system.

The garage/4S shop obtains the information of the insurance voucher by code-scanning, being code-scanned, or character string input, thereby obtaining relevant information of the user such as, for example, the identity information of the user or the identity information of the vehicle. In addition, the garage/4S shop can also obtain repair project information of the user, the proportion of project cost borne by the user, and so on. The information may be obtained not through the interface of the server terminal of the payment system, but only through a system interface between the garage/4S shop and the insurance company, which is not limited in the embodiment.

According to the relevant information of the user, the garage/4S shop may determine the repair project, the proportion of the cost borne by the user, and the like, then determine fee settlement information, and send the insurance voucher settlement request to the server terminal of the payment system to request the settlement of the fee corresponding to the insurance voucher. When the insurance voucher is settled, an insurance voucher settlement interface provided by the server terminal of the payment system is required.

Information related to the claim settlement fee can be carried in the insurance voucher settlement request. The information related to the claim settlement fee may be expressed in various manners. For example, the information related to the claim settlement fee may include the amount of the fee that the insurance company should bear. For another example, the information related to the claim settlement fee may include the repair project and the settlement method. The information related to the claim settlement fee may also include the proportion that the insurance company or the user should bear, in order to determine the proportion of the entire settlement fee that the insurance company and the user should bear.

The garage/4S shop is taken as an example. For example, the insurance company can stipulate that, for a repair project of glass replacement, the repair cost is 1,000 yuan in the garage and 1,500 yuan in the 4S shop. When the garage settles as the repair facility, the repair cost is 1,000 yuan; when the 4S shop settles as the repair facility, the repair cost is 1,500 yuan. Assuming that the current repair facility is a garage, the garage may send the insurance voucher settlement request in which information of the cost being 1,000 yuan is carried, or information of the repair project being glass replacement and the settlement method being the garage is carried. A fee proportion may be further carried in the insurance voucher settlement request. For example, if the user's responsibility is 30%, information about that the insurance company's fee proportion is 70% may be further carried in the insurance voucher settlement request. The fee proportions of the same user in different repair projects may be the same or different.

In addition, in the embodiment, when the insurance voucher is used, the garage/4S shop may also write off the insurance voucher, and mark the insurance voucher as used. At this time, the insurance voucher settlement request may also be referred to as an insurance voucher write-off request, and may be used for requesting the write-off of the insurance voucher in addition to requesting the settlement of the fee corresponding to the insurance voucher.

In 220, the server terminal of the payment system sends a payment request to the insurance company.

After receiving the insurance voucher settlement request from the garage/4S shop, the server terminal of the payment system may send the payment request.

The information related to the claim settlement fee, such as the repair project and the settlement method, or the settlement amount, may be carried in the payment request.

In addition, one or more of the identification information of the user, the risk information of the user, and the like may be further carried in the payment request. The risk information of the user can be used for the insurance company to select a payment determination method that matches the risk information of the user.

In 222, the insurance company confirms the payment.

After the payment request is received, the insurance company may confirm the payment.

In an embodiment, the insurance company may automatically or manually confirm the payment request.

For example, when the insurance company manually confirms the payment request, the method of review and confirmation can be determined according to the risk information in the payment request: the higher the risk of the user (the lower the credit) is, the stricter the payment review standard is; the lower the risk of the user (the higher the credit) is, the looser the payment review standard is, and the payment can even be confirmed directly without review.

The method of review and confirmation by the insurance company may be, for example, offline confirmation by telephone, checking whether the frequency of insurance claim reports is abnormal, and so on.

In 224, the insurance company sends a payment instruction to the server terminal of the payment system.

After the insurance company confirms the payment, the insurance company can send a payment instruction to an account B of the garage/4S shop opened in the server terminal of the payment system through an account A opened in the server terminal of the payment system. For example, if the insurance company needs to pay 1000 yuan to the garage/4S shop, the insurance company sends a payment instruction that requests the server terminal of the payment system to transfer 1000 yuan from the account A to the account B, and so on. The identification information of the insurance voucher, or the identification information of the user, or the identification information of the vehicle may be carried in the payment instruction, so that the garage/4S shop can find a corresponding money management voucher record and write off the fee.

In 226, after receiving the payment instruction, the server terminal of the payment system completes the payment to the garage/4S shop.

After receiving the payment instruction, the server terminal of the payment system may deduct the amount to be paid from the account of the insurance company, and increase the corresponding amount in the account of the garage/4S shop to complete the payment.

In 228, the garage/4S shop receives the payment.

After the server terminal of the payment system completes the payment, the garage/4S shop may receive the payment from the insurance company.

At this point, the entire process from the user reporting the vehicle insurance claim to the garage/4S shop receiving the payment ends. Throughout the process, the user does not need to pay in advance the garage/4S shop for the fee that the insurance company should bear, thereby realizing quick settlement of the insurance fee. The insurance company can also prevent fraudulent incidents from happening as much as possible.

In the embodiment of FIG. 2, steps 220 to 226 are optional. The insurance company may also set the automatic payment confirmation. After the insurance voucher write-off request is received, the server terminal of the payment system automatically transfers money from the account of the insurance company to the account of the garage/4S shop to complete the payment.

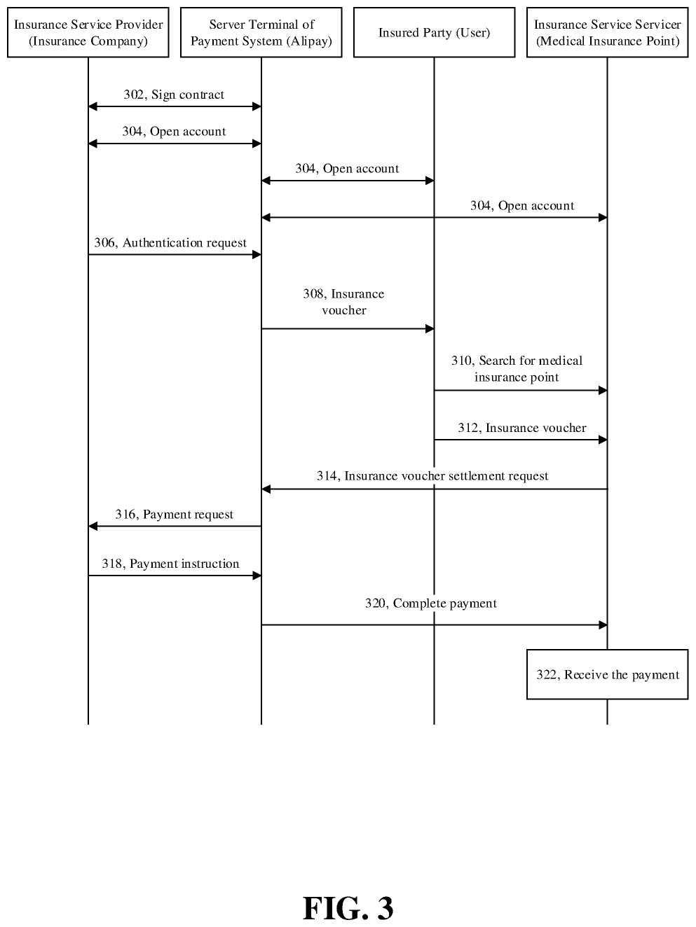

FIG. 3 is an interactive flowchart of a health insurance claim according to an embodiment. In the embodiment, the cost balancing subsystem is an insurance service provider or an insurance company; the cost transfer subsystem is a server terminal of the payment system; and the resource subsystem is an insurance service servicer, or a medical insurance point, and the like. For example, the medical insurance point may be a hospital or a pharmacy that provides medical insurance services according to the state or local regulations, or may be a hospital or a pharmacy that is contracted with an insurance company other than the hospital or pharmacy according to the state or local regulations.

In 302, the insurance company signs a contract with the server terminal of the payment system.

Similar to the vehicle insurance process, in the preparation stage, the insurance company may complete signing of the contract with the server terminal of the payment system such as Alipay to obtain a voucher issue function. As such, the insurance company can have the permission of sending an insurance voucher to a user. In the embodiment, the insurance voucher is a voucher for the user to pay the medical fee and the drug fee at the medical insurance point.

In 304, related parties of the insurance claim open accounts at the server terminal of the payment system.

In the embodiment, the related parties of the insurance claim include an insured party (user), an insurance service provider (insurance company), and an insurance service servicer (medical insurance point). The related parties of the insurance claim may open accounts in the payment system, so that the server terminal of the payment system such as Alipay can recognize the identity of a user. For details, reference may be made to step 204 of FIG. 2, and the details will not be elaborated here.

In 306, the insurance company sends an authentication request to the server terminal of the payment system.

In the embodiment, the insurance company may authenticate the user to Alipay when the user is insured or after the user is insured, for evaluating the risk information of the user and sending an insurance voucher to the user.

In 308, the server terminal of the payment sends an insurance voucher after the authentication succeeds.

The server terminal of the payment system may authenticate the user in a manner similar to step 212 in the embodiment shown in FIG. 2, and send the insurance voucher after the authentication succeeds. In the embodiment, the insurance voucher is a medical insurance voucher for a medical insurance insured person to pay the medical insurance fee in the medical insurance hospital or the medical insurance pharmacy.

In 310, the user searches for a medical insurance point.

In the embodiment, the user can search for a designated medical insurance point through a navigation module integrated in a client terminal of the payment system, such as GPS navigation, AR navigation, map navigation, etc., or search for a medical insurance point within a specified range. Definitely, the user can also search for the medical insurance point in other manners, which is not limited by the embodiment.

In 312, the user uses the insurance voucher.

In the embodiment, the user may use the insurance voucher in various occasions. For example, when a user is hospitalized in a specified medical insurance hospital, the insurance voucher may be used to pay for the portion of the hospitalization fee that the insurance company should bear. For another example, after the user finishes a visit to an outpatient clinic at a specified medical insurance hospital, the insurance voucher may be used to pay for the part of the consultation fee and the medical fee that the insurance company should bear. For another example, when the user buys medicine at the specified medical insurance pharmacy, the insurance voucher can be used to pay for the part of the medicine expenses that the insurance company should bear.

In the embodiment, the specified medical insurance hospital and the specified medical insurance pharmacy refer to a hospital or pharmacy that can provide medical insurance-covered services as specified by the insurance company, and may include a locally designated medical insurance hospital or medical insurance pharmacy, and may also include a non-locally designated medical insurance hospital or medical insurance pharmacy.

In the embodiment, the user may use the insurance voucher by code-scanning or being code-scanned, or by inputting the identification information of the insurance voucher.

In 314, the medical insurance point sends an insurance voucher use request to the server terminal of the payment system.

Similar to the step 218 of FIG. 2, the medical insurance point can also obtain the information of the insurance voucher by code-scanning, being code-scanned, or inputting character string, thereby obtaining relevant information of the user.

The medical insurance point may determine the fee settlement information according to the charging item related to the medical insurance in the charging items and the settlement method, and send an insurance voucher settlement request to the server terminal of the payment system. Similarly, the information related to the claim settlement fee can be carried in the insurance voucher settlement request. The information related to the claim settlement fee may be expressed in various manners. For example, the information related to the claim settlement fee may include the amount of the fee that the insurance company should bear. For another example, the information related to the claim settlement fee may include the medical insurance charging item and the settlement method.

Different types of medical points may have different settlement methods in health insurance related to medical insurance. For example, the medical fee of a tertiary hospital is reimbursed by 85%, the medical fee of a secondary hospital is reimbursed by 90%, the medical fee of a primary hospital is reimbursed by 95%, the fee of a pharmacy is reimbursed by 92%, and so on. The actual settlement manner may be different, which is not limited in the embodiment.

In addition, in the embodiment, the insurance voucher can be used as the medical insurance payment voucher, and can be always valid during the insurance period. In this case, the medical insurance point does not need to write off the insurance voucher. The insurance voucher may also be one-off, and in this case, the medical insurance point may write off the insurance voucher.

In 316, the server terminal of the payment system sends a payment request to the insurance company.

In 318, the insurance company confirms the payment.

In 320, the insurance company sends a payment instruction to the server terminal of the payment system.

In 322, after receiving the payment instruction, the server terminal of the payment system completes the payment to the medical insurance point.

In 324, the medical insurance point receives the payment.

For the specific implementation of the steps 316 to 324, reference may be made to the steps 220 to 228 of FIG. 2, which will not be elaborated in the embodiment.

In the embodiment, if the insurance voucher is one-off, a new insurance voucher may be issued to the user when the insurance company receives the payment request or when the server terminal of the payment system receives the insurance voucher settlement request. Or, the user may notify the insurance company offline to issue a new voucher.

The specific embodiments have been described above. Other embodiments fall within the scope of the appended claims. In some cases, actions or steps recorded in the claims can be performed in a different order than that in the embodiments and the expected results can still be achieved. In addition, the processes depicted in the accompanying drawings are not necessarily required to be in the shown particular order or successive order to achieve the expected results. In some implementation manners, multitasking and parallel processing are also possible or may be advantageous.

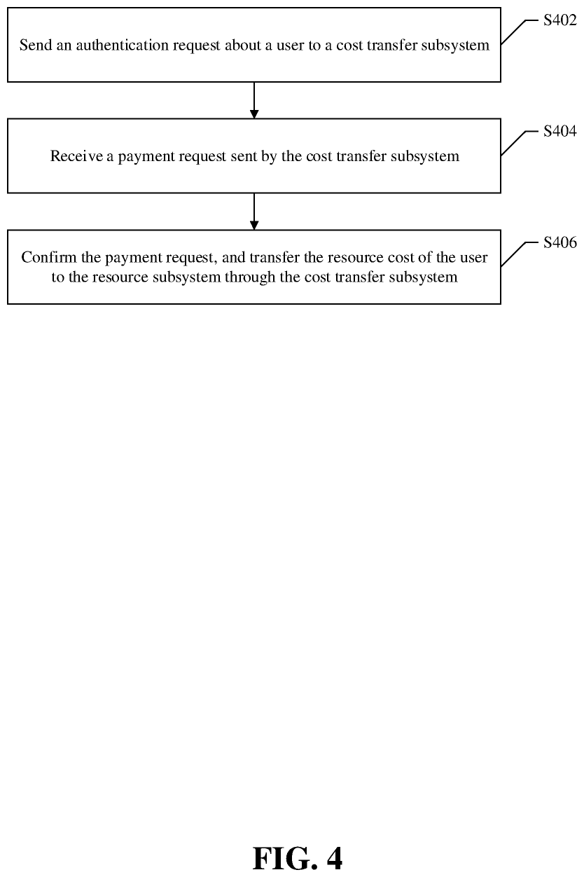

FIG. 4 is a flowchart of a data processing method according to an embodiment. In the embodiment, the method is performed by a cost balancing subsystem. The method may include the following steps.

In S402, an authentication request about a user is sent to a cost transfer subsystem.

The authentication request is used for requesting authentication of the user.

In S404, a payment request sent by the cost transfer subsystem is received.

The payment request is used for requesting payment of a resource cost of a client terminal of the user and is sent by the resource subsystem according to the directed electronic voucher presented by the client terminal of the user, and the directed electronic voucher is sent to the client terminal of the user by the cost transfer subsystem according to an authentication result.

In S406, the payment request is confirmed, and the resource cost of the user is transferred to the resource subsystem through the cost transfer subsystem.

In the embodiment, the authentication of the user is completed and the directed electronic voucher is issued through the cost transfer subsystem, the payment request fed back by the cost transfer subsystem is received, and the payment of the resource cost is completed through the cost transfer subsystem, thereby enabling the user terminal to reduce the period of advance payment of the resource cost while reducing or avoiding an additional resource cost paid by the cost balancing system.

For the specific implementation of the embodiment, reference may be made to the method performed by the cost balancing subsystem in the embodiment shown in FIG. 1, and the method performed by the insurance service provider (insurance company) in the embodiment shown in FIG. 2 and FIG. 3, which will not be elaborated.

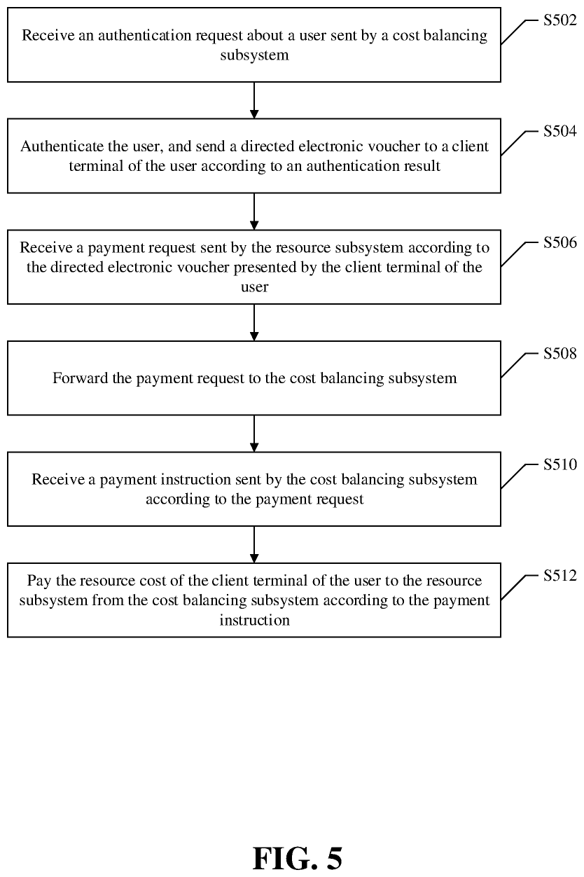

FIG. 5 is a flowchart of a data processing method according to an embodiment. In the embodiment, the method is performed by a cost transfer subsystem. The method may include the following steps.

In S502, an authentication request about a user sent by a cost balancing subsystem is received.

The authentication request is used for requesting authentication of the user.

In S504, the user is authenticated, and a directed electronic voucher is sent to a client terminal of the user according to an authentication result.

The directed electronic voucher is used as a payment voucher for the directed resource cost of the client terminal of the user.

In S506, a payment request sent by the resource subsystem according to the directed electronic voucher presented by the client terminal of the user is received.

The payment request is used for requesting payment of the resource cost of the client terminal of the user.

In S508, the payment request is forwarded to the cost balancing subsystem.

In S510, a payment instruction sent by the cost balancing subsystem according to the payment request is received.

The payment instruction is used for paying the resource cost of the client terminal of the user to the resource subsystem.

In S512, the resource cost of the client terminal of the user is paid to the resource subsystem from the cost balancing subsystem according to the payment instruction.

In the solution of insurance claim settlement, the method of the embodiment can be implemented as follows.

An authentication request about a user sent by an insurance service provider is received, wherein the identity credit review request is used for requesting authentication of the user.

The user is authenticated, and after the authentication succeeds, an insurance voucher is sent to an account of the user in the payment system, wherein the insurance voucher is used for settlement of the claim settlement fee of the user.

An insurance voucher settlement request sent by the insurance service servicer is received after the insurance voucher of the user is used, wherein the insurance voucher settlement request is used for requesting settlement of the claim settlement fee.

The claim settlement fee is settled according to the insurance voucher settlement request.

In the embodiment, the authentication of the user is completed according to the authentication request about the user and the directed electronic voucher is issued, the payment is requested from the cost balancing subsystem according to the payment request sent by the resource subsystem, and the payment of the resource cost is completed after the payment instruction is received, thereby enabling the user terminal to reduce the period of advance payment of the resource cost while reducing or avoiding an additional resource cost paid by the cost balancing system.

For the specific implementation of the embodiment, reference can be made to the method performed by the cost transfer subsystem in the embodiment shown in FIG. 1, and the method performed by the server terminal of the payment system (Alipay) in the embodiment shown in FIG. 2 and FIG. 3, which will not be elaborated.

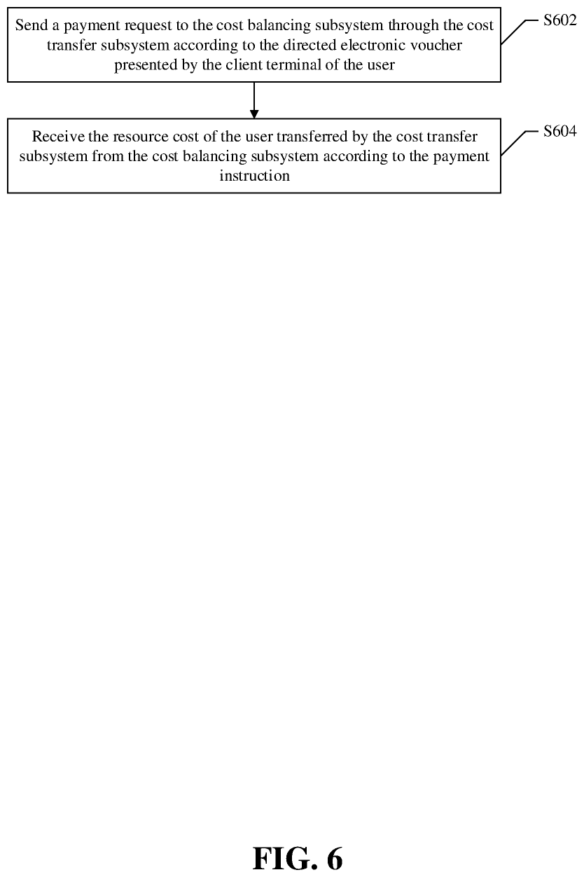

FIG. 6 is a flowchart of a data processing method according to an embodiment. In the embodiment, the method is performed by a resource subsystem. The method may include the following steps.

In S602, a payment request is sent to the cost balancing subsystem through the cost transfer subsystem according to the directed electronic voucher presented by the client terminal of the user.

The payment request is used for requesting payment of the resource cost of the user, and the directed electronic voucher is sent to the client terminal of the user by the cost transfer subsystem according to an authentication result for an authentication request about the user from the cost balancing subsystem, and the directed electronic voucher is used as a payment voucher for a directed resource cost of the user.

In S604, the resource cost of the user transferred by the cost transfer subsystem from the cost balancing subsystem according to the payment instruction is received.

The payment instruction is sent by the cost balancing subsystem to the cost transfer subsystem after the payment request forwarded by the cost transfer subsystem is confirmed, and the payment instruction is used for paying the resource cost of the user.

In the embodiment, payment of the resource cost corresponding to the directed electronic voucher is requested from the cost balancing subsystem through the cost transfer subsystem according to the directed electronic voucher. Then, the resource cost transferred by the cost transfer subsystem from the cost balancing subsystem is received, thereby enabling the user terminal to reduce the period of advance payment of the resource cost while reducing or avoiding an additional resource cost paid by the cost balancing system.

For the specific implementation of the embodiment, reference can be made to the method performed by the resource subsystem in the embodiment shown in FIG. 1, and the method performed by the insurance service servicer in the embodiment shown in FIG. 2 and FIG. 3, which will not be elaborated.

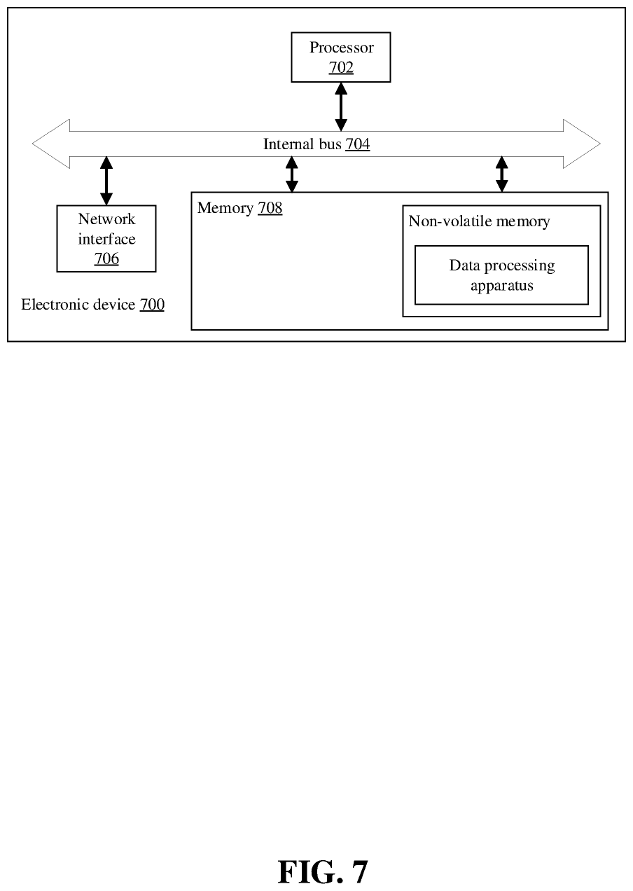

FIG. 7 is a schematic diagram of an electronic device 700 according to an embodiment. For example, the electronic device 700 may implement the cost balancing subsystem described above. Referring to FIG. 7, the electronic device 700 may include a processor 702, and, in some embodiments, may further include an internal bus 704, a network interface 706, and a memory 708. The memory 708 may include a high-speed Random-Access Memory (RAM), or a non-volatile memory such as at least one magnetic disk memory. The electronic device may further include hardware required by other services.

The processor 702, the network interface 706, and the memory 708 may be interconnected through the internal bus 704, and the internal bus 704 may be an Industry Standard Architecture (ISA) bus, a Peripheral Component Interconnect (PCI) bus, an Extended Industry Standard Architecture (EISA) bus, or the like. The internal bus 704 may be classified into an address bus, a data bus, a control bus, and the like. For ease of representation, only one two-way arrow is shown in FIG. 7, but it does not mean that there is only one bus or one type of buses.

The memory 708 is configured to store a program. For example, the program may include program codes including a computer operation instruction. The memory 708 may include the non-volatile memory, and provide an instruction and data to the processor 702.

The processor 702 reads, from the non-volatile memory, the corresponding computer program and runs the computer program, thus forming a program of a data processing apparatus at the logic level. The processor 702 executes the program stored in the memory 708, and is configured to perform the following operations:

sending an authentication request about a user to a cost transfer subsystem, the authentication request being used for requesting authentication of the user;

receiving a payment request sent by the cost transfer subsystem, wherein the payment request is used for requesting payment of a resource cost of a client terminal of the user and is sent by the resource subsystem according to the directed electronic voucher presented by the client terminal of the user, and the directed electronic voucher is sent to the client terminal of the user by the cost transfer subsystem according to an authentication result; and

confirming the payment request and transferring the resource cost of the user to the resource subsystem through the cost transfer subsystem.

The method performed by the cost balancing subsystem disclosed in the embodiment shown in FIG. 1, and the method performed by the insurance service provider (insurance company) of the embodiment shown in FIG. 2 and FIG. 3 can be applied to the processor or implemented by the processor. The processor may be an integrated circuit chip having signal processing capability. In the process of implementation, various steps of the above methods may be completed by an integrated logic circuit of hardware in the processor or an instruction in the form of software. The processor may be a general-purpose processor, including a Central Processing Unit (CPU), a Network Processor (NP), etc.; or may be a Digital Signal Processor (DSP), an Application Specific Integrated Circuit (ASIC), a Field-Programmable Gate Array (FPGA) or another programmable logic device, discrete gate or transistor logic device, or discrete hardware component. The methods, steps, and logical block diagrams disclosed in the embodiments can be implemented or performed. The general-purpose processor may be a microprocessor, or the processor may be any conventional processor or the like. The steps of the methods disclosed in the embodiments of this application may be directly performed by a hardware decoding processor, or may be performed by a combination of hardware and software modules in the decoding processor. The software module can be located in a mature storage medium in the field, such as a random-access memory, a flash memory, a read-only memory, a programmable read-only memory or electrically erasable programmable memory, a register, and the like. The storage medium is located in the memory, and the processor reads the information in the memory and implements the steps of the above methods in combination with its hardware.

In the embodiment, the authentication of the user is completed and the directed electronic voucher is issued through the cost transfer subsystem, the payment request fed back by the cost transfer subsystem is received, and the payment of the resource cost is completed through the cost transfer subsystem, thereby enabling the user terminal to reduce the period of advance payment of the resource cost while reducing or avoiding an additional resource cost paid by the cost balancing system.

The electronic device can also perform the method of FIG. 4, and implement the functions of the cost balancing subsystem in the embodiment shown in FIG. 1, and the functions of the insurance service provider (insurance company) in the embodiment shown in FIG. 2 and FIG. 3, which will not be elaborated.

A computer readable storage medium storing one or more programs is further proposed in the embodiment. The one or more programs include an instruction, and when executed by a portable electronic device including multiple applications, the instruction enables the portable electronic device to execute the method of the embodiment shown in FIG. 4.

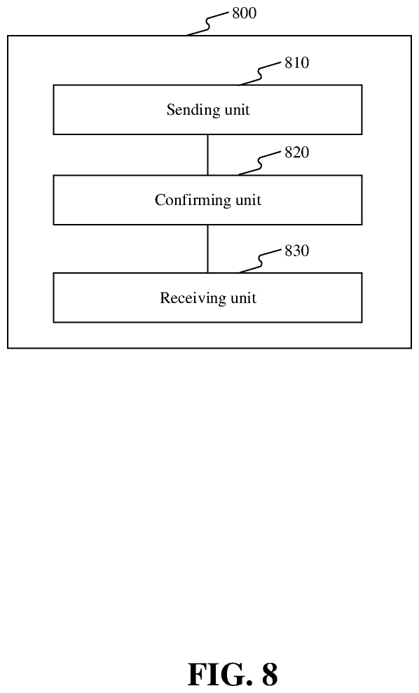

FIG. 8 is a schematic diagram of a data processing apparatus 800 according to an embodiment. Referring to FIG. 8, the data processing apparatus 800 may include:

a sending unit 810 configured to send an authentication request about a user to a cost transfer subsystem, the authentication request being used for requesting authentication of the user;

a receiving unit 830 configured to receive a payment request sent by the cost transfer subsystem, wherein the payment request is used for requesting payment of a resource cost of a client terminal of the user and is sent by the resource subsystem according to the directed electronic voucher presented by the client terminal of the user, and the directed electronic voucher is sent to the client terminal of the user by the cost transfer subsystem according to an authentication result; and

a confirming unit 820 configured to confirm the payment request;

wherein the sending unit 810 is further configured to transfer the resource cost of the user to the resource subsystem through the cost transfer subsystem.

In the embodiment, the authentication of the user is completed and the directed electronic voucher is issued through the cost transfer subsystem, the payment request fed back by the cost transfer subsystem is received, and the payment of the resource cost is completed through the cost transfer subsystem, thereby enabling the user terminal to reduce the period of advance payment of the resource cost while reducing or avoiding an additional resource cost paid by the cost balancing system.

The data processing apparatus 800 can also perform the method of FIG. 4, and implement the functions of the cost balancing subsystem in the embodiment shown in FIG. 1, and the functions of the insurance service provider (insurance company) in the embodiment shown in FIG. 2 and FIG. 3, which will not be elaborated.

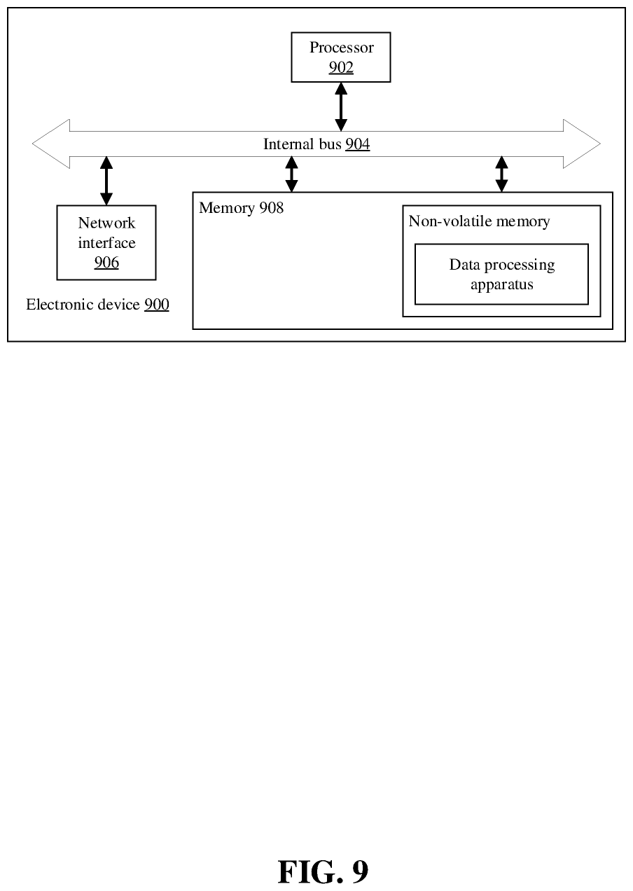

FIG. 9 is a schematic diagram of an electronic device 900 according to an embodiment. For example, the electronic device 900 may implement the cost transfer subsystem described above. Referring to FIG. 9, the electronic device 900 may include a processor 902, and, in some embodiments, may further include an internal bus 904, a network interface 906, and a memory 908. The memory 908 may include a high-speed Random-Access Memory (RAM), or a non-volatile memory such as at least one magnetic disk memory. The electronic device may further include hardware required by other services.

The processor 902, the network interface 906, and the memory 908 may be interconnected through the internal bus 904, and the internal bus 904 may be an Industry Standard Architecture (ISA) bus, a Peripheral Component Interconnect (PCI) bus, an Extended Industry Standard Architecture (EISA) bus, or the like. The bus may be classified into an address bus, a data bus, a control bus, and the like. For ease of representation, only one two-way arrow is shown in FIG. 9, but it does not mean that there is only one bus or one type of buses.

The memory 908 is configured to store a program. For example, the program may include program codes including a computer operation instruction. The memory 908 may include the non-volatile memory, and provide an instruction and data to the processor.

The processor 902 reads, from the non-volatile memory, the corresponding computer program and runs the computer program, thus forming a program of a data processing apparatus at the logic level. The processor 902 executes the program stored in the memory 908, and is configured to perform the following operations:

receiving an authentication request about a user sent by a cost balancing subsystem, the authentication request being used for requesting authentication of the user;

sending a directed electronic voucher to a client terminal of the user according to an authentication result, the directed electronic voucher being used as a payment voucher for a directed resource cost of the client terminal of the user;

receiving a payment request sent by a resource subsystem according to the directed electronic voucher presented by the client terminal of the user, the payment request being used for requesting payment of the resource cost of the client terminal of the user;

forwarding the payment request to the cost balancing subsystem;

receiving a payment instruction sent by the cost balancing subsystem according to the payment request, the payment instruction being used for paying the resource cost of the client terminal of the user to the resource subsystem; and

paying the resource cost of the client terminal of the user to the resource subsystem from the cost balancing subsystem according to the payment instruction.

The method performed by the cost transfer subsystem disclosed in the embodiment shown in FIG. 1, and the method performed by the server terminal of the payment system (Alipay) of the embodiment shown in FIG. 2 and FIG. 3 can be applied to the processor or implemented by the processor. The processor may be an integrated circuit chip having signal processing capability. In the process of implementation, various steps of the above methods may be completed by an integrated logic circuit of hardware in the processor or an instruction in the form of software. The processor may be a general-purpose processor, including a Central Processing Unit (CPU), a Network Processor (NP), etc.; or may be a Digital Signal Processor (DSP), an Application Specific Integrated Circuit (ASIC), a Field-Programmable Gate Array (FPGA) or another programmable logic device, discrete gate or transistor logic device, or discrete hardware component. The methods, steps, and logical block diagrams disclosed in the embodiments of this application can be implemented or performed. The general-purpose processor may be a microprocessor, or the processor may be any conventional processor or the like. The steps of the method disclosed in the embodiments of this application may be directly performed by a hardware decoding processor, or may be performed by a combination of hardware and software modules in the decoding processor. The software module can be located in a mature storage medium in the field, such as a random-access memory, a flash memory, a read-only memory, a programmable read-only memory or electrically erasable programmable memory, a register, and the like. The storage medium is located in the memory, and the processor reads the information in the memory and implements the steps of the above method in combination with its hardware.

In the embodiment, the authentication of the user is completed according to the authentication request about the user and the directed electronic voucher is issued, the payment is requested from the cost balancing subsystem according to the payment request sent by the resource subsystem, and the payment of the resource cost is completed after the payment instruction is received, thereby enabling the user terminal to reduce the period of advance payment of the resource cost while reducing or avoiding an additional resource cost paid by the cost balancing system.

The electronic device can also perform the method of FIG. 5, and implement the functions of the cost transfer subsystem in the embodiment shown in FIG. 1, and the functions of the server terminal of the payment system (Alipay) in the embodiment shown in FIG. 2 and FIG. 3, which will not be elaborated.

A computer readable storage medium storing one or more programs is further proposed in the embodiment. The one or more programs include an instruction, and when executed by a portable electronic device including multiple applications, the instruction enables the portable electronic device to execute the method of the embodiment shown in FIG. 4.

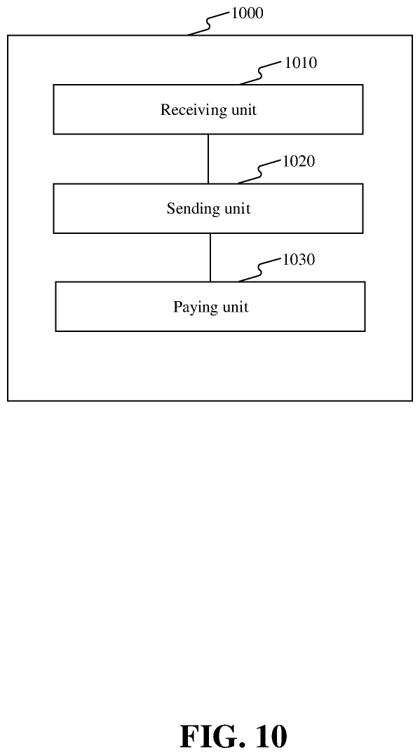

FIG. 10 is a schematic diagram of a data processing apparatus 1000 according to an embodiment. Referring to FIG. 10, the data processing apparatus 1000 may include:

a receiving unit 1010 configured to receive an authentication request about a user sent by a cost balancing subsystem, the authentication request being used for requesting authentication of the user;

a sending unit 1020 configured to send a directed electronic voucher to a client terminal of the user according to an authentication result, the directed electronic voucher being used as a payment voucher for a directed resource cost of the client terminal of the user;

wherein the receiving unit 1010 is further configured to receive a payment request sent by a resource subsystem according to the directed electronic voucher presented by the client terminal of the user, the payment request being used for requesting payment of the resource cost of the client terminal of the user;

the sending unit 1020 is further configured to forward the payment request to the cost balancing subsystem; and

the receiving unit 1010 is further configured to receive a payment instruction sent by the cost balancing subsystem according to the payment request 1010, the payment instruction being used for paying the resource cost of the client terminal of the user to the resource subsystem; and

a paying unit 1030 configured to pay the resource cost of the client terminal of the user to the resource subsystem from the cost balancing subsystem according to the payment instruction.

In the embodiment, the authentication of the user is completed according to the authentication request about the user and the directed electronic voucher is issued, the payment is requested from the cost balancing subsystem according to the payment request sent by the resource subsystem, and the payment of the resource cost is completed after the payment instruction is received, thereby enabling the user terminal to reduce the period of advance payment of the resource cost while reducing or avoiding an additional resource cost paid by the cost balancing system.

The data processing apparatus 1000 can also perform the method of FIG. 5, and implement the functions of the cost transfer subsystem in the embodiment shown in FIG. 1, and the functions of the server terminal of the payment system (Alipay) in the embodiment shown in FIG. 2 and FIG. 3, which will not be elaborated.

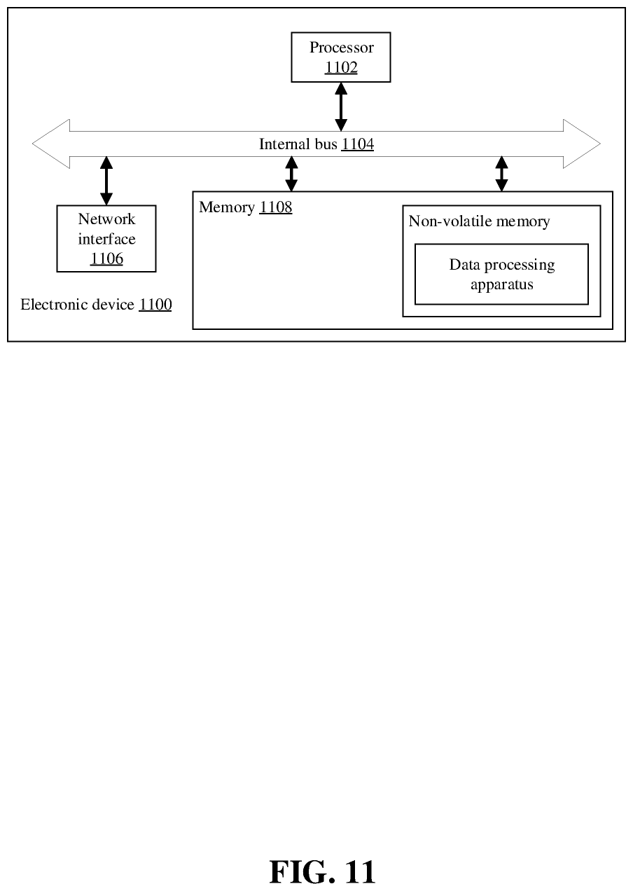

FIG. 11 is a schematic diagram of an electronic device 1100 according to an embodiment. For example, the electronic device 1100 may implement the resource subsystem described above. Referring to FIG. 11, the electronic device 1100 includes a processor 1102, and in some embodiments, further includes an internal bus 1104, a network interface 1106, and a memory 1108. The memory 1108 may include a high-speed Random-Access Memory (RAM), or a non-volatile memory such as at least one magnetic disk memory. The electronic device may further include hardware required by other services.

The processor 1102, the network interface 1106, and the memory 1108 may be interconnected through the internal bus 1104, and the internal bus 1104 may be an Industry Standard Architecture (ISA) bus, a Peripheral Component Interconnect (PCI) bus, an Extended Industry Standard Architecture (EISA) bus, or the like. The internal bus 1104 may be classified into an address bus, a data bus, a control bus, and the like. For ease of representation, only one two-way arrow is shown in FIG. 11, but it does not mean that there is only one bus or one type of buses.

The memory 1108 is configured to store a program. For example, the program may include program codes including a computer operation instruction. The memory 1108 may include the non-volatile memory, and provide an instruction and data to the processor 1102.

The processor 1102 reads, from the non-volatile memory, the corresponding computer program and runs the computer program, thus forming a program of a data processing apparatus at the logic level. The processor 1102 executes the program stored in the memory, and is configured to perform the following operations:

sending, through a cost transfer subsystem, a payment request to a cost balancing subsystem according to a directed electronic voucher presented by a client terminal of a user, the payment request being used for requesting payment of a resource cost of the user, wherein the directed electronic voucher is sent to the client terminal of the user by the cost transfer subsystem according to an authentication result for an authentication request about the user from the cost balancing subsystem, and the directed electronic voucher is used as a payment voucher for a directed resource cost of the user; and

receiving the resource cost of the user transferred by the cost transfer subsystem from the cost balancing subsystem according to a payment instruction, wherein the payment instruction is sent by the cost balancing subsystem to the cost transfer subsystem after the payment request forwarded by the cost transfer subsystem is confirmed, and the payment instruction is used for paying the resource cost of the user.

The method performed by the resource subsystem disclosed in the embodiment shown in FIG. 1 of this application, and the method performed by the insurance service servicer of the embodiment shown in FIG. 2 and FIG. 3 can be applied to the processor or implemented by the processor. The processor may be an integrated circuit chip having signal processing capability. In the process of implementation, various steps of the above methods may be completed by an integrated logic circuit of hardware in the processor or an instruction in the form of software. The processor may be a general-purpose processor, including a Central Processing Unit (CPU), a Network Processor (NP), etc.; or may be a Digital Signal Processor (DSP), an Application Specific Integrated Circuit (ASIC), a Field-Programmable Gate Array (FPGA) or another programmable logic device, discrete gate or transistor logic device, or discrete hardware component. The methods, steps, and logical block diagrams disclosed in the embodiments of this application can be implemented or performed. The general-purpose processor may be a microprocessor, or the processor may be any conventional processor or the like. The steps of the methods disclosed in the embodiments of this application may be directly performed by a hardware decoding processor, or may be performed by a combination of hardware and software modules in the decoding processor. The software module can be located in a mature storage medium in the field, such as a random-access memory, a flash memory, a read-only memory, a programmable read-only memory or electrically erasable programmable memory, a register, and the like. The storage medium is located in the memory, and the processor reads the information in the memory and implements the steps of the above method in combination with its hardware.

In the embodiment, payment of the resource cost corresponding to the directed electronic voucher is requested from the cost balancing subsystem through the cost transfer subsystem according to the directed electronic voucher. Then, the resource cost transferred by the cost transfer subsystem from the cost balancing subsystem is received, thereby enabling the user terminal to reduce the period of advance payment of the resource cost while reducing or avoiding an additional resource cost paid by the cost balancing system.

The electronic device can also perform the method of FIG. 6, and implement the functions of the resource subsystem in the embodiment shown in FIG. 1, and the functions of the insurance service servicer in the embodiment shown in FIG. 2 and FIG. 3, which will not be elaborated.

A computer readable storage medium storing one or more programs is further proposed in the embodiment. The one or more programs include an instruction, and when executed by a portable electronic device including multiple applications, the instruction enables the portable electronic device to execute the method of the embodiment shown in FIG. 6.

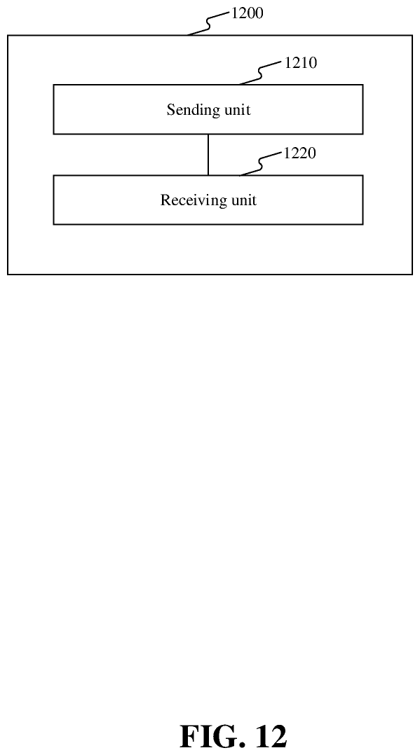

FIG. 12 is a schematic diagram of a data processing apparatus 1200 according to an embodiment. Referring to FIG. 12, the data processing apparatus 1200 may include:

a sending unit 1210 configured to send, through a cost transfer subsystem, a payment request to a cost balancing subsystem according to a directed electronic voucher presented by a client terminal of a user, the payment request being used for requesting payment of a resource cost of the user, wherein the directed electronic voucher is sent to the client terminal of the user by the cost transfer subsystem according to an authentication result for an authentication request about the user from the cost balancing subsystem, and the directed electronic voucher is used as a payment voucher for a directed resource cost of the user; and

a receiving unit 1220 configured to receive the resource cost of the user transferred by the cost transfer subsystem from the cost balancing subsystem according to a payment instruction, wherein the payment instruction is sent by the cost balancing subsystem to the cost transfer subsystem after the payment request forwarded by the cost transfer subsystem is confirmed, and the payment instruction is used for paying the resource cost of the user.

In the embodiment, payment of the resource cost corresponding to the directed electronic voucher is requested from the cost balancing subsystem through the cost transfer subsystem according to the directed electronic voucher. Then, the resource cost transferred by the cost transfer subsystem from the cost balancing subsystem is received, thereby enabling the user terminal to reduce the period of advance payment of the resource cost while reducing or avoiding an additional resource cost paid by the cost balancing system.

The data processing apparatus 1200 can also perform the method of FIG. 6, and implement the functions of the resource subsystem in the embodiment shown in FIG. 1, and the functions of the insurance service servicer in the embodiment shown in FIG. 2 and FIG. 3, which will not be elaborated.

A data processing system is further disclosed in the embodiment, and includes a cost balancing subsystem, a cost transfer subsystem, a resource subsystem, and a user client terminal subsystem, wherein

the cost balancing subsystem is configured to send an authentication request about a user to the cost transfer subsystem, the authentication request being used for requesting authentication of the user;

the cost transfer subsystem is configured to receive the authentication request, and send a directed electronic voucher to the user client terminal subsystem of the user according to an authentication result, the directed electronic voucher being used as a payment voucher for a directed resource cost of the user;

the user client terminal subsystem is configured to receive the directed electronic voucher about the user sent by the cost transfer subsystem, and present the directed electronic voucher to the resource subsystem;

the resource subsystem is configured to send, according to the directed electronic voucher presented by the client terminal of the user, a payment request to the cost balancing subsystem through the cost transfer subsystem, the payment request being used for requesting payment of the resource cost of the user; and

the cost balancing subsystem is further configured to confirm the payment request and transfer the resource cost of the user to the resource subsystem through the cost transfer subsystem.

It should be understood that in the embodiment, the cost balancing subsystem may also implement the functions of the cost balancing subsystem of the embodiment shown in FIG. 1, and the functions of the insurance service provider (insurance company) in the embodiment shown in FIG. 2 and FIG. 3. The cost transfer subsystem can also implement the functions of the cost transfer subsystem in the embodiment shown in FIG. 1, and the functions of the server terminal of the payment system (Alipay) in the embodiment shown in FIG. 2 and FIG. 3. The resource subsystem can also implement the functions of the resource subsystem in the embodiment shown in FIG. 1 and the functions of the insurance service servicer in the embodiment shown in FIG. 2 and FIG. 3. The user client terminal subsystem can also implement the function of the user client terminal in the embodiment shown in FIG. 1, and the function of the insured party in the embodiment shown in FIG. 2 and FIG. 3. Those will not be elaborated here.

The above description is merely preferred embodiments of this application, and is not intended to limit the protection scope of this application. Any modification, equivalent replacement, improvement and the like made within the spirit and principle of this application should be included in the protection scope of this application.

The system, apparatus, module or unit illustrated in the above embodiments may be implemented by a computer chip or an entity, or by a product having a certain function. A typical implementation device is a computer. For example, the computer may be a personal computer, a laptop computer, a cellular phone, a camera phone, a smart phone, a personal digital assistant, a media player, a navigation device, an email device, a game console, a tablet computer, a wearable device, or a combination of any of these devices.

The computer readable medium includes non-volatile and volatile media as well as movable and non-movable media, and may implement information storage by means of any method or technology. The information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store information accessible to the computing device. According to the definition in this text, the computer readable medium does not include transitory media, such as a modulated data signal and a carrier.

It should be further noted that the terms “include,” “comprise” or other variations thereof are intended to cover non-exclusive inclusion, so that a process, method, commodity or device including a series of elements not only includes the elements, but also includes other elements not clearly listed, or further includes elements inherent to the process, method, commodity or device. In the absence of more limitations, an element defined by “including a/an . . . ” does not exclude that the process, method, commodity or device including the element further has other identical elements.

Although the specification has been described in conjunction with specific embodiments, many alternatives, modifications and variations will be apparent to those skilled in the art. Accordingly, the following claims embrace all such alternatives, modifications and variations that fall within the terms of the claims.

1. A data processing method, comprising:
sending, by a cost balancing subsystem, an authentication request about a user to a cost transfer subsystem, the authentication request requesting authentication of the user;
sending, by the cost transfer subsystem according to an authentication result, a directed electronic voucher to a client terminal of the user, the directed electronic voucher being used as a payment voucher for a resource cost of the user for a directed resource;
sending, by a resource subsystem according to the directed electronic voucher, a payment request to the cost balancing subsystem through the cost transfer subsystem, the directed electronic voucher being presented by the client terminal of the user, and the payment request requesting payment of the resource cost of the user; and
confirming, by the cost balancing subsystem, the payment request, and transferring, by the cost balancing subsystem, the resource cost of the user to the resource subsystem through the cost transfer subsystem.

2. The method of claim 1, wherein
identification information of the directed resource that is directed to the user is carried in the authentication request and the directed electronic voucher, and the identification information of the directed resource that is directed to the user identifies an object having permission of using the directed electronic voucher and determines the resource cost that the cost balancing subsystem should bear.

3. The method of claim 2, wherein the sending, by a resource subsystem according to the directed electronic voucher presented by the client terminal of the user, a payment request to the cost balancing subsystem through the cost transfer subsystem comprises:
when an object using a resource corresponding to the resource cost of the user is an object having the permission of using the directed electronic voucher, and the resource corresponding to the resource cost of the user comprises at least one directed resource carried in the directed electronic voucher, sending, by the resource subsystem according to the directed electronic voucher presented by the client terminal of the user, the payment request to the cost balancing subsystem through the cost transfer subsystem.

4. The method of claim 2, wherein at least one of the following is further carried in the directed electronic voucher:
validity period information; and
a resource subsystem identifier,
wherein the validity period information defines an effective use period of the directed electronic voucher, and the resource subsystem identifier identifies a resource subsystem having the permission of using the directed electronic voucher.

5. The method of claim 4, wherein the sending, by a resource subsystem according to the directed electronic voucher presented by the client terminal of the user, a payment request to the cost balancing subsystem through the cost transfer subsystem comprises:
if the validity period information is carried in the directed electronic voucher and the current date is within the validity period, or resource subsystem identifiers are carried in the directed electronic voucher and the identifier of the resource subsystem is one of the resource subsystem identifiers carried in the directed electronic voucher, sending, by the resource subsystem according to the directed electronic voucher presented by the client terminal of the user, the payment request to the cost balancing subsystem by the cost transfer subsystem.

6. The method of claim 1, wherein the authentication result comprises a credit indicator or risk indicator of the user, and the credit indicator or risk indicator of the user is carried in the directed electronic voucher.

7. The method of claim 6, further comprising:
receiving, by the client terminal of the user, the directed electronic voucher,
wherein the receiving the directed electronic voucher by the client terminal of the user comprises:
if the credit indicator of the user is lower than a predetermined credit indicator or the risk indicator of the user is higher than a predetermined risk indicator, performing risk authentication on the user and confirming reception of the directed electronic voucher after the authentication succeeds.

8. The method of claim 6, wherein
the credit indicator or risk indicator of the user is further carried in the payment request, and
the confirming, by the cost balancing subsystem, the payment request comprises:
confirming, by the cost balancing subsystem, the payment request according to a confirming method corresponding to the credit indicator or risk indicator of the user.

9. The method of claim 2, wherein one of the following is carried in the payment request:
the resource cost;
a resource item identifier, and a cost verification manner corresponding to the resource item identifier; and
a resource item identifier, a cost verification manner corresponding to the resource item identifier, and a resource cost proportion that the cost balancing subsystem should bear.

10. The method of claim 1, wherein the sending, by a cost balancing subsystem, an authentication request about a user to a cost transfer subsystem comprises:
after the cost balancing subsystem confirms providing the user with the resource cost directed to the user, sending the authentication request about the user to the cost transfer subsystem.

11. An electronic device, comprising:
a processor; and
a memory arranged to store a computer executable instruction, wherein when executed, the executable instruction causes the processor to perform the following operations:
sending an authentication request about a user to a cost transfer subsystem, the authentication request requesting authentication of the user;
receiving a payment request sent by the cost transfer subsystem, wherein the payment request requesting payment of a resource cost of a client terminal of the user and is sent by a resource subsystem according to a directed electronic voucher presented by the client terminal of the user, and the directed electronic voucher is sent to the client terminal of the user by the cost transfer subsystem according to an authentication result; and
confirming the payment request and transferring the resource cost of the user to the resource subsystem through the cost transfer subsystem.

12. An electronic device, comprising:
a processor; and
a memory arranged to store a computer executable instruction, wherein when executed, the executable instruction causes the processor to perform the following operations:
receiving an authentication request about a user sent by a cost balancing subsystem, the authentication request being used for requesting authentication of the user;
authenticating the user, and sending a directed electronic voucher to a client terminal of the user according to an authentication result, the directed electronic voucher being used as a payment voucher for a resource cost of the client terminal of the user for a directed resource;
receiving a payment request sent by a resource subsystem according to the directed electronic voucher, the directed electronic voucher being presented by the client terminal of the user, and the payment request being used for requesting payment of a resource cost of the client terminal of the user;
forwarding the payment request to the cost balancing subsystem;
receiving a payment instruction sent by the cost balancing subsystem according to the payment request, the payment instruction being configured to pay the resource cost of the client terminal of the user to the resource subsystem; and
paying the resource cost of the client terminal of the user to the resource subsystem from the cost balancing subsystem according to the payment instruction.

13. An electronic device, comprising:
a processor; and
a memory arranged to store a computer executable instruction, wherein when executed, the executable instruction causes the processor to perform the following operations:
sending, through a cost transfer subsystem, a payment request to a cost balancing subsystem according to a directed electronic voucher presented by a client terminal of a user, the payment request requesting payment of a resource cost of the user, wherein the directed electronic voucher is sent to the client terminal of the user by the cost transfer subsystem according to an authentication result for an authentication request about the user from the cost balancing subsystem, and the directed electronic voucher is used as a payment voucher for a resource cost of the user for a directed resource; and
receiving the resource cost of the user transferred by the cost transfer subsystem from the cost balancing subsystem according to a payment instruction, wherein the payment instruction is sent by the cost balancing subsystem to the cost transfer subsystem after the payment request forwarded by the cost transfer subsystem is confirmed, and the payment instruction is configured to pay the resource cost of the user.
